(19) United States
(12) Patent Application Publication
(10) Pub. No.: US 2016/0274955 A1
(43) Pub. Date: Sep. 22, 2016

(54) Method and Device for Activating and Controlling Application in Multi-Screen System, and Mobile Terminal

(71) Applicant: ZTE CORPORATION, Shenzhen, Guangdong Province (CN)

(72) Inventor: Bo HU, Shenzhen, Guangdong Province (CN)

(73) Assignee: ZTE CORPORATION, Shenzhen, Guangdong Province (CN)

(21) Appl. No.: 15/027,957

(22) PCT Filed: Apr. 21, 2014
(86) PCT No.: PCT/CN2014/075854

§ 371 Date: Apr. 7, 2016

(30) Foreign Application Priority Data
Oct. 8, 2013 (CN) 201310467527.0

(51) Int. Cl. G06F 9/52; G06F 3/14; G06F 9/48

(52) U.S. Cl. CPC G06F 9/52; G06F 9/4843; G06F 3/14

(57) ABSTRACT

A method and a device for activating and controlling an application in a multi-screen system, and a terminal are provided. The method includes: the permissions of an application to be activated are required; it is detected whether there is a permission in the permissions conflicting with the permissions of a specified application; and if there is a conflicting permission, the application to be activated is activated and controlled in accordance with a preset action indication corresponding to the conflicting permission.

### TECHNICAL FIELD

The present invention relates to the technical field of communications, and in particular to a method and a device for activating and controlling an application in a multi-screen system, and a mobile terminal thereof.

### BACKGROUND

Nowadays, the screen of mobile terminal is becoming bigger and bigger, and the multi-screen technology of mobile terminal is growing mature. However, since most applications are developed based on a single screen, many applications will cause conflict during the running process when the multi-screen technology is adopted. For example, one application turns on WIFI during usage while another application turns off WIFI during usage, which brings unnecessary troubles to users. These problems will not occur in the single-screen application, because applications are activated and turned in turn in the single-screen mode. For example, if to use the WIFI function, a sound application will turn on WIFI when activated and turn off WIFI when closed. However, in the dual-screen mode, since the current application has not been closed while another application is activated, the whole process is disturbed. Actually, these conflicts ultimately are caused by permissions conflict. However, existing activation process will not check the permissions of applications, but check certain permission when this permission is needed.

Therefore, when the multi-screen technology is used, how to resolve the problem of permissions conflict occurring among applications that coexist in a foreground simultaneously becomes a technical problem to be solved.

### SUMMARY

The present invention provides a method and a device for activating and controlling an application in a multi-screen system, and a mobile terminal, to solve the problem of permission conflict occurring among applications that coexist in a foreground simultaneously when the multi-screen technology is adopted in related art.

According to one aspect of the embodiment of the present invention, a method for activating and controlling an application in a multi-screen system is provided, including:
the permissions of an application to be activated are acquired; it is detected whether there is a permission in the permission conflicting with the permission of a specified application; and if there is a conflicting permission, the application to be activated is activated and controlled in accordance with a preset action indication corresponding to the conflicting permission, wherein the specified application refers to an application that coexists with the application to be activated in a foreground after the application to be activated is activated.

Preferably, in the method of the embodiment of the present invention, the step of detecting whether there is a permission in the permission conflicting with the permission of a specified application and, if there is a conflicting permission, conducting activation and control on the application to be activated in accordance with a preset control action specifically includes:
comparing the permission of the application to be activated with the permission of the specified application, and it is judged whether there is a common permission;
if there is a common permission, it is detected whether the common permission is contained in a preconfigured permission-action list; for the permission contained in the permission-action list, the application to be activated is activated and controlled in accordance with a corresponding action indication, wherein the permissions recorded in the permission-action list are preconfigured conflicting permissions.

Preferably, in the method of the embodiment of the present invention, the action indication includes:
forbidding activating the application to be activated, or, sending a permission conflict alarm message, or automatically closing the application in the specified application conflicting with the corresponding permission, or, activating the application to be activated after removing the conflicting permission.

Preferably, the method of the embodiment of the present invention further includes: when the permission-action list is called by a user, an action change indication towards one or more permissions given by the user is acquired so as to update the current permission-action list;
wherein the permission-action list provides action change options, through which the user can change the actions corresponding to different permissions.

Preferably, the method of the embodiment of the present invention further includes: if there is no conflicting permission, the application to be activated is activated according to a normal activation flow.

According to another aspect of the embodiment of the present invention, a device for activating and controlling an application in a multi-screen system is provided, including:
an acquisition unit, which is configured to acquire the permissions of an application to be activated;
a detection unit, which is configured to detect whether there is a permission in the permission conflicting with the permissions of a specified application, wherein the specified application refers to an application that coexists with the application to be activated in a foreground after the application to be activated is activated;
a control unit, which is configured to conduct activation and control, if the detection unit detects a conflicting permission, on the application to be activated in accordance with a preset action indication corresponding to the conflicting permission.

Preferably, in the device of the embodiment of the present invention:
the detection unit is further configured to compare the permission of the application to be activated with the permission of the specified application, and judge whether there is a common permission; if there is a common permission, detect whether the common permission is contained in a preconfigured permission-action list, wherein the permission recorded in the permission-action list is a preconfigured conflicting permission;
the control unit is further configured to conduct, for the permission contained in the permission-action list, activation and control on the application to be activated in accordance with a corresponding action indication.

Preferably, in the device of the embodiment of the present invention, the action indication includes:
forbidding activating the application to be activated, or, sending a permission conflict alarm message, or automatically closing the application in the specified application conflicting with the corresponding permission, or, activating the application to be activated after removing the conflicting permission.

Preferably, the device of the embodiment of the present invention further includes:
an update unit, which is configured to acquire, when the permission-action list is called by a user, the action change indication towards one or more permissions given by the user so as to update the current permission-action list;
wherein the permission-action list provides action change options, through which the user can change the actions corresponding to different permissions.

Preferably, in the device of the embodiment of the present invention, the control unit is further configured to activate the application to be activated according to a normal activation flow if the detection unit does not detect a conflicting permission.

In addition, the embodiment of the present invention also provides a mobile terminal, which is provided with a device provided by the embodiment of the present invention for activating and controlling an application in a multi-screen system.

The embodiment of the present invention has advantages as follows:
the embodiment of the present invention changes the activation process of applications, specifically, it first acquires the permission of an application to be activated, then judges whether the permission is conflicting with the permission of an application that is activated and will coexist with the to-be-activated application in a foreground, then adopts a corresponding action if there is a conflicting permission, and finally enters the original application activation process after ensuring there is no problem, in this way, preventive measures can be taken before the application is activated, thereby enhancing system stability and not affecting user experience.

### BRIEF DESCRIPTION OF THE DRAWINGS

In order to better understand the embodiments in the present invention or the technical scheme in related art, accompanying drawings needed in the embodiments of the present invention or in the description of related art are simply illustrated below; obviously, those accompanying drawings described below are only part embodiments of the present invention; for the ordinary staff in the art, other accompanying drawings can be obtained according to these accompanying drawings without creative labor.

FIG. 1 is a flowchart of a method for activating and controlling an application in a multi-screen system according to the embodiment of the present invention;

FIG. 2 is a structure diagram of a device for activating and controllin an application in a multi-screen system according to the embodiment of the present invention; and

FIG. 3 is another structure diagram of a device for activating and controlling an application in a multi-screen system according to the embodiment of the present invention.

### DETAILED DESCRIPTION OF THE EMBODIMENTS

The technical scheme provided in the embodiment of the present invention is described below clearly and completely in conjunction with the accompanying drawings mentioned in the embodiment of the present invention; obviously, the described embodiment is part embodiments of the present invention only, but all the embodiments. Based on the embodiment of the present invention, all other embodiments obtained by the ordinary staff in the art without creative efforts are intended to be included in the scope of protection of the present invention.

In order to resolve the problem of permission conflict probably occurring among multiple open applications coexisting in a foreground simultaneously when the multi-screen technology is used, the embodiment of the present invention provides a method and a device for activating and controlling an application in a multi-screen system, and a mobile terminal. The embodiment of the present invention changes the activation process of applications, specifically, it conducts a permission conflict judgement and conducts corresponding activation and control according to the conflicting permission before an application is activated, in this way, preventive measures can be taken before the application is activated, thereby avoiding the permission conflict occurring among applications coexisting in a foreground simultaneously.

### Embodiment 1

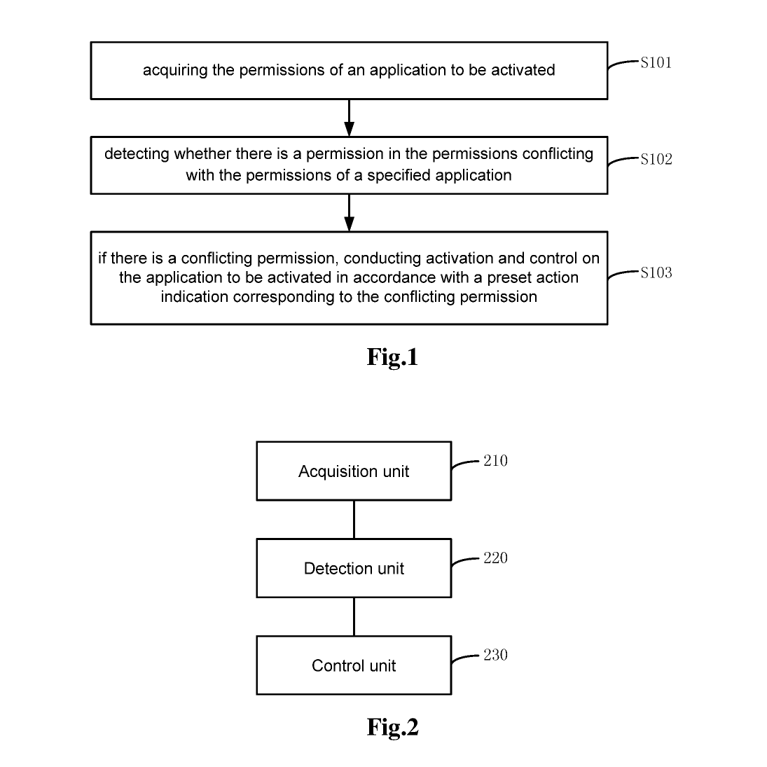

The embodiment of the present invention provides a method for activating and controlling an application in a multi-screen system, which as shown in FIG. 1 includes the following steps:

S101: acquiring the permissions of an application to be activated.

The method to acquire the permissions of an application might be but not limited to calling through a system interface.

S102: detecting whether there is a permission in the permissions conflicting with the permissions of a specified application, wherein the specified application refers to an application that coexists with the application to be activated in a foreground after the application to be activated is activated. That is to say, the permission detection mentioned in the embodiment of the present invention is just for the applications probably running in the foreground simultaneously, but for the application running in the background.

S103: if there is a conflicting permission, conducting activation and control on the application to be activated in accordance with a preset action indication corresponding to the conflicting permission.

Preferably, if there is no conflicting permission, the alternative scheme of this step is: activating the application to be activated according to a normal activation flow.

Preferably, in this embodiment, the action indication includes but not limited to:
forbidding activating the application to be activated, that is to say, the conflicting permission completely affects the activation of the application; therefore, if the conflicting permission belongs to this type of permission, the given action indication might be forbidding activating;
or, sending a permission conflict alarm message, that is to say, the existence of the conflicting permission does not necessary affect the usage of users; therefore, if the conflicting permission belongs to this type of permission, the given action indication is to send an alarm message to the user; if the user knows clearly what will be caused by the permission conflict, he/she can neglect the alarm; of course, the user also can adopt other measures to avoid the occurrence of permission conflict;
or, automatically closing the application in the specified application conflicting with the corresponding permission;
or, activating the application to be activated after removing the conflicting permission.

It should be noted that the above action indications are examples only, but exhaustively; those skilled in the art can configure settings flexibility according to specific needs; the embodiment of the present invention does not limit the specific operation of the action indication.

Preferably, in the embodiment of the present invention, a preferred implementation is provided for the permission conflict judgement, specifically as below:
after acquiring the permission of the application to be activated, comparing the permission of the application to be activated with the permission of the specified application, and judging whether there is a common permission;
if there is a common permission, detecting whether the common permission is contained in a preconfigured permission-action list; for the permission contained in the permission-action list, conducting activation and control on the application to be activated in accordance with a corresponding action indication, wherein the permission recorded in the permission-action list is a preconfigured conflicting permission.

That is to say, in this preferred implementation, a mapping table is preconfigured for a conflicting permission and an action; when to conduct a conflict judgement, it is only needed to conduct corresponding control on the permission contained in the mapping table; this judgement method is simple, easy and greatly improves the judgement detection efficiency,

Preferably, in the embodiment of the present invention, an update scheme is provided for the permission-action list, specifically as below: when the permission-action list is called by a user, acquiring an action change indication towards one or more permissions given by the user so as to update the current permission-action list;
wherein the permission-action list provides an action change option, through which a user can change the action corresponding to different permissions.

To sum up, the method in this embodiment changes the activation process of applications, specifically, it first acquires the permission of an application to be activated, then judges whether the permission is conflicting with the permission of an application that is activated and will coexist with the to-be-activated application in a foreground, then adopts a corresponding action if there is a conflicting permission, and finally enters the original application activation process after ensuring there is no problem (a user confirms or adopts some measures to ensure that no conflict will occur), in this way, preventive measures can be taken before the application is activated, thereby enhancing system stability and not affecting user experience.

### Embodiment 2

The embodiment of the present invention provides a method for activating and controlling an application in a multi-screen system, which is a further illustration of the method described in Embodiment 1 and specifically includes the following control process:

1. Pre-configuration:

Preferably, engineers construct a permission-action list according to experiences, to be called during the following permission control.

The permission-action list allows a user to modify, that is, it is updated according to the choice of the user. The format of the permission-action list is that each permission corresponds to a corresponding responding action, for example, Camera hardware control permission-disable permission to activate, Bluetooth enabling permission-alarm.

2. Activating the control process of a new application in a multi-screen mode:

Step 1: acquiring the permission list of all current applications displayed (for example, in a dual-screen mode, supposing the application running in the foreground is A and B).

Step 2: acquiring the permission list of an application to be activated (C).

Step 3: acquiring the common permission of Application C and the application that coexists with Application C in the foreground after Application C is activated; if there is no common permission, enter Step 6 (for example, in a dual-screen mode, Application B is switched to Application C, if activated successfully application A and Application C coexist in the foreground, at this time, Application A is the coexisting application, here, Application C and Application A might be the same application).

Step 4: judging whether the common permission is contained in the permission-action list; if not, enter Step 6; otherwise, enter Step 5.

Step 5: for the permission contained in the permission-action list, executing the corresponding action in the list.

For example, if a certain permission corresponds to an action “forbidding activating the application to be activated”, do not activate Application C, directly end the process; if a certain permission corresponds to an action “alarm”, let the user to select through an alarm message; if the user selects end, then the activation process is ended; if the user selects ignore, enter Step 6.

Step 6: entering the process of activating Application C normally.

To make the implementation process of the present invention more clear, a specific application example is provided below, with the application scene of dual-screen system, on which the applications currently displayed are QQ and short message interface. At this time, the screen on which the short message interface is located is changed to activate WeChat through application switch.

The specific control process of the application example is as follows:

Step 1: acquiring the permissions of QQ, for example, GPS, hardware control (audio, video, camera and so on), network communication and other permissions.

Step 2: acquiring the permissions of WeChat, for example, network communication, GPS, and hardware control and other permissions.

Step 3: comparing the permissions of QQ and WeChat, to acquire the common permission.

Obviously, the two applications have many common permissions, however some common permission can coexist, for example, network communication, while some common permission will cause resource conflict when coexisting, for example, GPS permission, camera in the hardware control and other permissions. Therefore, it is needed to call a permission-action list to acquire the corresponding permission that probably will cause permission conflict.

Step 4: calling a permission-action list, determining which common permission is contained in the list; for the permission contained in the list, executing an operation according to the corresponding action.

Supposing the common permission contained in the permission-action list is GPS permission and Camera permission; then, the action corresponding to GPS in the permission-action list is warning (because GPS resource conflict has a small impact on the usage of users, thus it can be set as warning); the action corresponding to camera in the permission-action list is “activate after removing this permission”. During specific activation and control, an alarm message of GPS permission conflict will be sent to a user, for the user to decide whether to ignore the conflict or to perform other control; for the camera permission, during the application activation the camera permission will be removed.

Step 5: temporarily disabling the camera permission of the to-be-activated application (WeChat) through a system interface, then activating WeChat, and recovering the camera permission after the WeChat application exits.

### Embodiment 3

Corresponding to Embodiment 1, the embodiment of the present invention provides a device for activating and controlling an application in a multi-screen system, which as shown in FIG. 2 includes:
an acquisition unit 210, which is configured to acquire the permission of an application to be activated;
a detection unit 220, which is configured to detect whether there is a permission in the permission conflicting with the permission of a specified application, wherein the specified application refers to an application that coexists with the application to be activated in a foreground after the application to be activated is activated;
a control unit 230, which is configured to conduct activation and control, if the detection unit 220 detects a conflicting permission, on the application to be activated in accordance with a preset action indication corresponding to the conflicting permission.

Preferably, in this embodiment, the control unit is 230 further configured to activate the application to be activated according to a normal activation flow if there is no conflicting permission.

Preferably, in this embodiment, the action indication includes but not limited to:
forbidding activating the application to be activated, that is to say, the conflicting permission completely affects the activation of the application; therefore, if the conflicting permission belongs to this type of permission, the given action indication might be forbidding activating;
or, sending a permission conflict alarm message, that is to say, the existence of the conflicting permission does not necessary affect the usage of users; therefore, if the conflicting permission belongs to this type of permission, the given action indication is to send an alarm message to the user; if the user knows clearly what will be caused by the permission conflict, he/she can neglect the alarm; of course, the user also can adopt other measures to avoid the occurrence of permission conflict;
or, automatically closing the application in the specified application conflicting with the corresponding permission;
or, activating the application to be activated after removing the conflicting permission.

It should be noted that the above action indications are examples only, but exhaustively; those skilled in the art can configure settings flexibility according to specific needs; the embodiment of the present invention does not limit the specific operation of the action indication.

Preferably, in the embodiment of the present invention, a preferred implementation is provided for the permission conflict judgement, specifically as below:
the detection unit 220 is further configured to: compare the permission of the application to be activated with the permission of the specified application, and judge whether there is a common permission; if there is a common permission, detect whether the common permission is contained in a preconfigured permission-action list, wherein the permission recorded in the permission-action list is a preconfigured conflicting permission;
the control unit 230 is further configured to conduct, for the permission contained in the permission-action list, activation and control on the application to be activated in accordance with a corresponding action indication.

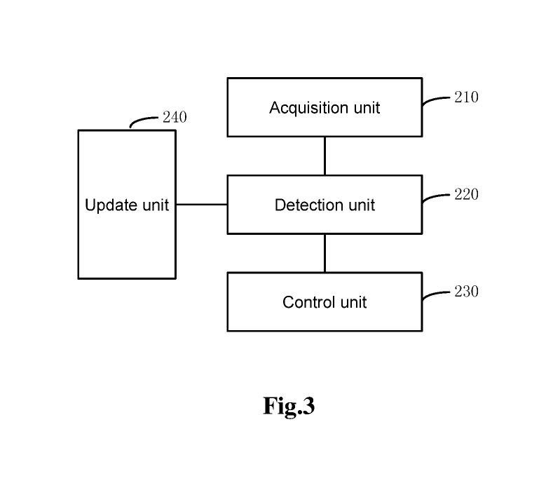

Preferably, in the embodiment of the present invention, an update scheme is provided for the permission-action list; as shown in FIG. 3, the device in this embodiment further includes:
an update unit 240, which is configured to acquire, when the permission-action list is called by a user, an action change indication towards one or more permissions given by the user so as to update the current permission-action list;
wherein the permission-action list provides an action change option, through which a user can change the action corresponding to different permissions. To sum up, the device in this embodiment first acquires the permission of an application to be activated, then judges whether the permission is conflicting with the permission of an application that is activated and will coexist with the to-be-activated application in a foreground, then adopts a corresponding action if there is a conflicting permission, and finally enters the original application activation process after ensuring there is no problem (a user confirms or adopts some measures to ensure that no conflict will occur), in this way, preventive measures can be taken before the application is activated, thereby enhancing system stability and not affecting user experience.

### Embodiment 4

The embodiment of the present invention provides a mobile terminal, which is provided with a device provided in Embodiment 3 for activating and controlling an application in a multi-screen system, thus the mobile terminal also can realize corresponding technical effects; since the foregoing content has given a detailed description, no further description is needed here.

Obviously, those skilled in the art can make various changes and modifications to the present invention without departing from the spirit and scope of the present invention. In this way, if these changes and modifications made to the present invention are included in the scope of the claims or equivalent technologies of the present invention, these changes and modifications shall be included in the present invention.

### INDUSTRIAL APPLICABILITY

The technical scheme provided by the embodiment of the present invention is applicable to the technical field of communications, which changes the activation process of applications. Before a certain application is activated, a permission conflict judgement is conducted, and a corresponding activation and control is conducted according to the conflicting permission, so that preventive measures can be taken before the application is activated, thereby avoiding the problem of permission conflict which may be caused when two applications coexist in a foreground simultaneously.

1. A method for activating and controlling an application in a multi-screen system, comprising:
acquiring permissions of an application to be activated;
detecting whether there is a permission in the permissions conflicting with permissions of a specified application, wherein the specified application refers to an application that coexists with the application to be activated in a foreground after the application to be activated is activated; and
when a conflicting permission exists, conducting activation and control on the application to be activated in accordance with a preset action indication corresponding to the conflicting permission.

2. The method according to claim 1, wherein the step of detecting whether there is a permission in the permission conflicting with the permission of a specified application and, when a conflicting permission exists, conducting activation and control on the application to be activated in accordance with a preset control action specifically comprises:
comparing the permissions of the application to be activated with the permissions of the specified application, and determining whether there is a common permission;
when there is a common permission between them, detecting whether the common permission is contained in a preconfigured permission-action list; for the permission contained in the permission-action list, conducting activation and control on the application to be activated in accordance with a corresponding action indication, wherein the permissions recorded in the permission-action list are preconfigured conflicting permissions.

3. The method according to claim 1, wherein the action indication comprises:
forbidding activating the application to be activated, or, sending a permission conflict alarm message, or automatically closing the application in the specified application conflicting with the corresponding permission, or, activating the application to be activated after removing the conflicting permission.

4. The method according to claim 2, further comprising: when the permission-action list is called by a user, acquiring an action change indication towards one or more permissions given by the user, and updating the current permission-action list;
wherein the permission-action list provides action change options, through which the user can change the actions corresponding to different permissions.

5. The method according to claim 1, further comprising: when no conflicting permission exists, activating the application to be activated according to a normal activation flow.

6. A device for activating and controlling an application in a multi-screen system, comprising
an acquisition unit, configured to acquire permissions of an application to be activated;
a detection unit, configured to detect whether there is a permission in the permission conflicting with permissions of a specified application, wherein the specified application refers to an application that coexists with the application to be activated in a foreground after the application to be activated is activated;
a control unit, configured to conduct activation and control, when the detection unit detects a conflicting permission, on the application to be activated in accordance with a preset action indication corresponding to the conflicting permission.

7. The device according to claim 6, wherein
the detection unit is further configured to: compare the permissions of the application to be activated with the permissions of the specified application, and judge whether there is a common permission; when the common permission exists, detect whether the common permission is contained in a preconfigured permission-action list, wherein permissions recorded in the permission-action list are preconfigured conflicting permissions;
the control unit is further configured to conduct, for the permission contained in the permission-action list, activation and control on the application to be activated in accordance with a corresponding action indication.

8. The device according to claim 6, wherein the action indication comprises:
forbidding activating the application to be activated, or, sending a permission conflict alarm message, or automatically closing the application in the specified application conflicting with the corresponding permission, or, activating the application to be activated after removing the conflicting permission.

9. The device according to claim 7, further comprising:
an update unit, configured to acquire, when the permission-action list is called by a user, an action change indication towards one or more permissions given by the user, and update the current permission-action list;
wherein the permission-action list provide action change options, through which the user can change the actions corresponding to different permissions.

10. A mobile terminal, which is provided with the device for activating and controlling an application in a multi-screen system according to claim 6.

11. The method according to claim 2, wherein the action indication comprises:
forbidding activating the application to be activated, or, sending a permission conflict alarm message, or automatically closing the application in the specified application conflicting with the corresponding permission, or, activating the application to be activated after removing the conflicting permission.

12. The method according to claim 2, further comprising:
when no conflicting permission exists, activating the application to be activated according to a normal activation flow.

13. The device according to claim 7, wherein the action indication comprises:
forbidding activating the application to be activated, or, sending a permission conflict alarm message, or automatically closing the application in the specified application conflicting with the corresponding permission, or, activating the application to be activated after removing the conflicting permission.

14. The mobile terminal according to claim 10, wherein
the detection unit is further configured to: compare the permissions of the application to be activated with the permissions of the specified application, and judge whether there is a common permission; when the common permission exists, detect whether the common permission is contained in a preconfigured permission-action list, wherein permissions recorded in the permission-action list are preconfigured conflicting permissions;
the control unit is further configured to conduct, for the permission contained in the permission-action list, activation and control on the application to be activated in accordance with a corresponding action indication.

15. The mobile terminal according to claim 10, wherein the action indication comprises:
forbidding activating the application to be activated, or, sending a permission conflict alarm message, or automatically closing the application in the specified application conflicting with the corresponding permission, or, activating the application to be activated after removing the conflicting permission.

16. The mobile terminal according to claim 17, further comprising:
an update unit, configured to acquire, when the permission-action list is called by a user, an action change indication towards one or more permissions given by the user, and update the current permission-action list;
wherein the permission-action list provide action change options, through which the user can change the actions corresponding to different permissions.
